(19) United States
(12) Patent Application Publication
(10) Pub. No.: US 2026/0121546 A1
(43) Pub. Date: Apr. 30, 2026

(54) PHASE-SHIFTED FULL BRIDGE CENTER-TAPPED CONVERTER WITH PROTECTION CIRCUIT

(71) Applicant: HANWHA SOLUTIONS CORPORATION, Seoul (KR)

(72) Inventors: Ju Il JIN, Seoul (KR); Sun Hang LEE, Seoul (KR)

(21) Appl. No.: 19/286,778

(22) Filed: Jul. 31, 2025

(30) Foreign Application Priority Data
Sep. 25, 2024 (KR) 10-2024-0129669

(51) Int. Cl. H02M 3/335; H02J 3/38; H02M 1/32

(52) U.S. Cl. CPC H02M 3/33584; H02J 3/381; H02M 1/32; H02M 3/33573; H02J 2101/24

(57) ABSTRACT

Provided is a phase-shifted full bridge center-tapped converter with a protection circuit. The converter includes a primary side circuit having a full bridge structure and a secondary side circuit having a center-tap structure. The converter further includes a protection circuit configured to transfer energy from the secondary side circuit to the primary side circuit, based on an operation stop.

### CROSS-REFERENCE TO RELATED APPLICATION

This application is based on and claims priority under 35 U.S.C. § 119 to Korean Patent Application No. 10-2024-0129669, filed on Sep. 25, 2024, in the Korean Intellectual Property Office, the disclosure of which is incorporated by reference herein in its entirety.

### BACKGROUND

### 1. Field

The disclosure relates to a phase-shifted full bridge (PSFB) center-tapped converter with a protection circuit.

### 2. Description of the Related Art

A phase-shifted full bridge (PSFB) center-tapped converter is capable of operating bidirectionally.

A converter, which converts and regulates power, may regulate voltage or convert direct current (DC) current into alternating current (AC) current. More specifically, a DC-DC converter may regulate DC voltages and supply power suitable for various circuits. An AC-DC converter may convert AC current into DC current so that generated energy may be used in various electronic products.

More specifically, a PSFB center-tapped converter may be used for DC-DC power conversion. In this case, the converter may convert power by using a full bridge circuit including four switching elements and a center tap of an output transformer. In particular, the converter may minimize switching loss by using a phase shift technique.

The aforementioned background technology is technical information possessed by the inventor for derivation of the disclosure or acquired by the inventor during the derivation of the disclosure, and is not necessarily prior art disclosed to the public before the application of the disclosure.

### SUMMARY

The disclosure provides a phase-shifted full bridge (PSFB) center-tapped converter with a secondary-side switch protection circuit.

The problems to be solved by the disclosure are not limited to those described above, and other problems and advantages of the disclosure that are not described herein will be understood from the following description and will be more clearly understood from embodiments. In addition, it will be appreciated that the problems to be solved by the disclosure and the advantages may be realized by the means indicated in the patent claims and combinations thereof.

According to an embodiment, a converter may include a primary side circuit having a full bridge structure and a secondary side circuit having a center-tap structure, wherein the converter may further include a protection circuit configured to transfer energy from the secondary side circuit to the primary side circuit, based on an operation stop.

In the converter, the protection circuit may include a plurality of switching elements and a plurality of diodes.

In the converter, the plurality of switching elements of the protection circuit may be turned on based on the operation stop while the converter is operating in a boost mode.

In the converter, the protection circuit may be further configured to turn on the plurality of switching elements included in the protection circuit, based on off signals of a first switching element and a second switching element included in the secondary side circuit.

In the converter, the protection circuit may be further configured to turn on the plurality of switching elements included in the protection circuit, based on the off signals of the first switching element and the second switching element included in the secondary side circuit and an operation mode of the converter.

In the converter, the protection circuit may be further configured to maintain turned-off states of the plurality of switching elements included in the protection circuit, based on a state in which an operation mode of the converter is a buck mode.

According to another embodiment, a photovoltaic power generation system may include one or more photovoltaic panels and a power conversion device configured to convert power generated by the one or more photovoltaic panels and transfer the converted power, wherein the power conversion device may include a converter, wherein the converter may include a primary side circuit having a full bridge structure and a secondary side circuit having a center tap structure, wherein the photovoltaic power generation system may further include a protection circuit configured to transfer energy from the secondary side circuit to the primary side circuit, based on an operation stop.

In the photovoltaic power generation system, the protection circuit may include a plurality of switching elements and a plurality of diodes.

In the photovoltaic power generation system, the plurality of switching elements of the protection circuit may be turned on based on the operation stop while the converter is operating in a boost mode.

In the photovoltaic power generation system, the protection circuit may be further configured to turn on the plurality of switching elements included in the protection circuit, based on off signals of a first switching element and a second switching element included in the secondary side circuit.

In the photovoltaic power generation system, the protection circuit may be further configured to turn on the plurality of switching elements included in the protection circuit, based on the off signals of the first switching element and the second switching element included in the secondary side circuit and an operation mode of the converter.

In the photovoltaic power generation system, the protection circuit may be further configured to maintain turned-off states of the plurality of switching elements included in the protection circuit, based on a state in which the operation mode of the converter is a buck mode.

According to another embodiment, a method of controlling a converter may include obtaining a signal related to an operation stop of the converter and controlling a protection circuit to transfer energy from a secondary side circuit to a primary side circuit, based on the signal related to the operation stop.

In the method, the controlling of the protection circuit to transmit the energy may be performed by using a plurality of switching elements and a plurality of diodes of the protection circuit.

In the method, the signal related to the operation stop may be obtained while the converter is operating in a boost mode, and the controlling of the protection circuit to transmit the energy may include turning on a plurality of switching elements of the protection circuit.

In the method, the signal related to the operation stop may be off signals of a first switching element and a second switching element included in the secondary side circuit, and the controlling of the protection circuit to transmit the energy may include turning on a plurality of switching elements included in the protection circuit, based on the off signals.

In the method, the obtaining of the signal related to the operation stop may include obtaining a signal related to an operation mode of the converter, the signal related to the operation stop may be off signals of a first switching element and a second switching element included in the secondary side circuit, and the controlling of the protection circuit to transmit the energy may include turning on a plurality of switching elements included in the protection circuit, based on the off signals and the signal related to the operation mode of the converter.

In the method, the controlling of the protection circuit to transmit the energy may include maintaining turned-off states of the plurality of switching elements included in the protection circuit, based on a state in which the signal related to the operation mode of the converter is a signal related to a buck mode.

Other aspects, features, and advantages of the disclosure will become better understood through the accompanying drawings, the appended claims, and the detailed description.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 illustrates a circuit of a conventional phase-shifted full bridge (PSFB) center-tapped converter according to an embodiment;

FIG. 2 illustrates a circuit of a PSFB center-tapped converter to which a secondary-side switching element protection circuit is added, according to an embodiment;

FIG. 3 illustrates a logic circuit of a secondary-side switching element protection circuit according to an embodiment;

FIGS. 4A and 4B illustrate implementations of a secondary-side switching element protection circuit according to another embodiment;

FIG. 5 illustrates an energy transfer path in case that a secondary-side switching element protection circuit is activated, according to an embodiment;

FIG. 6 schematically illustrates an example of a photovoltaic power generation system according to an embodiment;

FIG. 7 schematically illustrates another example of a photovoltaic power generation system according to an embodiment; and

FIG. 8 is a flowchart illustrating a method of controlling a converter, according to an embodiment.

### DETAILED DESCRIPTION

The advantages and features of the disclosure, and methods of achieving them will be clarified with reference to embodiments described below in detail with reference to the accompanying drawings. However, the disclosure is not limited to the embodiments presented below and may be implemented in various different forms. Rather, it will be understood that the disclosure includes all modifications, equivalents, and substitutes falling within the concept and technical scope of the disclosure. The embodiments presented below are provided so that the disclosure will be thorough and complete and will fully convey the concept of the disclosure to those of ordinary skill in the art. In describing the disclosure, when the detailed description of the relevant known technology is determined to obscure the gist of the disclosure, the detailed description thereof may be omitted.

The terms as used herein are only used to describe particular embodiments and are not intended to limit the disclosure. The singular forms as used herein are intended to include the plural forms as well unless the context clearly indicates otherwise. The terms “comprise,” “include,” or “have” as used in the present application are inclusive and therefore specify the presence of one or more stated features, integers, steps, operations, elements, components, or any combination thereof, but do not preclude the presence or addition of one or more other features, integers, steps, operations, elements, components, or any combination thereof.

Some embodiments of the disclosure may be represented by functional block configurations and various processes. Some or all of such functional blocks may be implemented in any number of hardware and/or software configurations that perform specific functions. For example, the functional blocks of the disclosure may be implemented by one or more microprocessors or may be implemented by circuit configurations for certain functions. In addition, for example, the functional blocks of the disclosure may be implemented in various programming or scripting languages. The functional blocks may be implemented as algorithms to be executed by one or more processors. In addition, the disclosure may employ conventional technologies for electronic environment setting, signal processing, and/or data processing. The terms such as “mechanism,” “element,” “means,” and “configuration” may be used broadly and are not limited to mechanical and physical configurations.

In addition, connecting lines or connecting members illustrated in the drawings are intended to represent functional connections and/or physical or circuit connections. In an actual device, connecting lines or connecting members illustrated in the drawings may represent connections between components by means of a variety of functional, physical, or circuit connections that may be substituted or added.

Hereinafter, the disclosure will be described in detail with reference to the attached drawings.

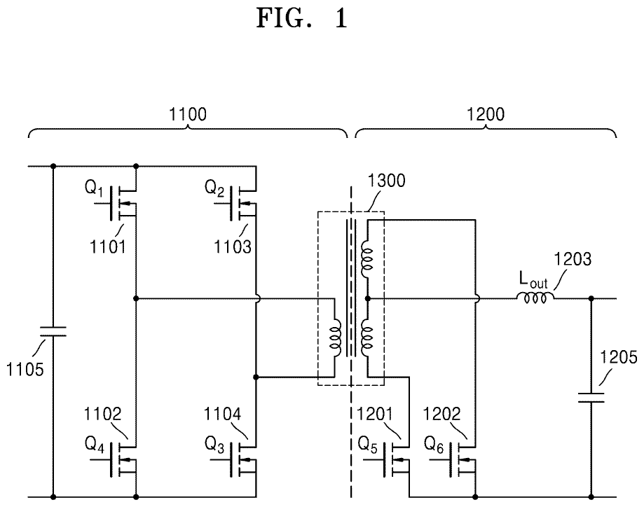

FIG. 1 illustrates a circuit of a conventional phase-shifted full bridge (PSFB) center-tapped converter according to an embodiment.

The PSFB center-tapped converter illustrated in FIG. 1 may function as a direct current-direct current (DC-DC) converter. The converter illustrated in FIG. 1 may convert an input DC voltage (or power) into a required different level of a DC voltage (or power) and output the converted DC voltage (or power). The DC-DC converter may be used to regulate a voltage so as to be usable in various electronic devices and systems.

The PSFB center-tapped converter illustrated in FIG. 1 may be a bidirectional DC-DC converter capable of converting voltages bidirectionally. In this case, the bidirectional DC-DC converter may refer to a device which is capable of converting power between a primary side and a secondary side connected to the bidirectional DC-DC converter not only in a direction from the primary side to the secondary side but also in a direction from the secondary side to the primary side. The bidirectional DC-DC converter may be utilized in various fields, such as renewable energy systems or electric vehicle charging.

The converter illustrated in FIG. 1 may include a primary side 1100 and a secondary side 1200. In some embodiments, a primary side 1100 circuit may include a plurality of switches (Q₁, Q₂, Q₃, and Q₄) 1101, 1102, 1103, and 1104 and a capacitor 1105. A secondary side 1200 circuit may include a plurality of switches (Q₅ and Q₆) 1201 and 1202, a capacitor 1205, and an inductor (Lₒᵤₜ) 1203. In some embodiments, the converter illustrated in FIG. 1 may include a transformer 1300.

For example, a full bridge converter included in the primary side 1100 circuit may be a converter which operates through a bridge circuit including the four switching elements (Q₁, Q₂, Q₃, and Q₄) 1101, 1102, 1103, and 1104. In some embodiments, the switching elements (Q₁, Q₂, Q₃, and Q₄) 1101, 1102, 1103, and 1104 included in the full bridge converter may operate to be alternately turned on and off.

The full bridge converter included in the primary side 1100 circuit may be a PSFB converter. The PSFB converter, which is a type of full bridge converter, may be a converter which uses a phase conversion technique so as to reduce switching loss and increase efficiency.

According to an embodiment, the secondary side 1200 circuit may be a circuit including a center-tap structure. The center-tap structure may refer to a structure which uses a method of generating two symmetrical voltages by adding a center tap to a coil of the secondary side 1200 circuit of the transformer 1300.

The PSFB center-tapped converter illustrated in FIG. 1 may operate in a buck mode which outputs a voltage lower than an input voltage or in a boost mode which outputs a voltage higher than an input voltage.

More specifically, the boost mode may refer to a mode which increases an output voltage so as to be higher than an input voltage. At this time, power may be transferred from the secondary side 1200 to the primary side 1100. The buck mode may refer to a mode which decreases an output voltage so as to be lower than an input voltage. At this time, power may be transferred from the primary side 1100 to the secondary side 1200.

The topology capable of operating directionally has a problem in which, in case that, when terminating the system while operating in the boost mode, the system is terminated without entering the buck mode, a voltage spike greater than or equal to a rated voltage occurs in the switching elements (Q₅ and Q₆) 1201 and 1202 included in the secondary side 1200 circuit, causing damage to the switching elements (Q₅ and Q₆) 1201 and 1202 of the secondary side 1200 circuit. Therefore, the conventional PSFG center-tapped converter, as illustrated in FIG. 1, has used a method of, when terminating the system while operating in the boost mode, entering the buck mode and then terminating the system.

However, in case that the system is terminated through the process of entering the buck mode, as described above, there is a problem in which the system is not terminated urgently because the system inevitably enters the buck mode even in a situation where the system has to be terminated urgently. Various embodiments described below may provide the solution to the problem described above.

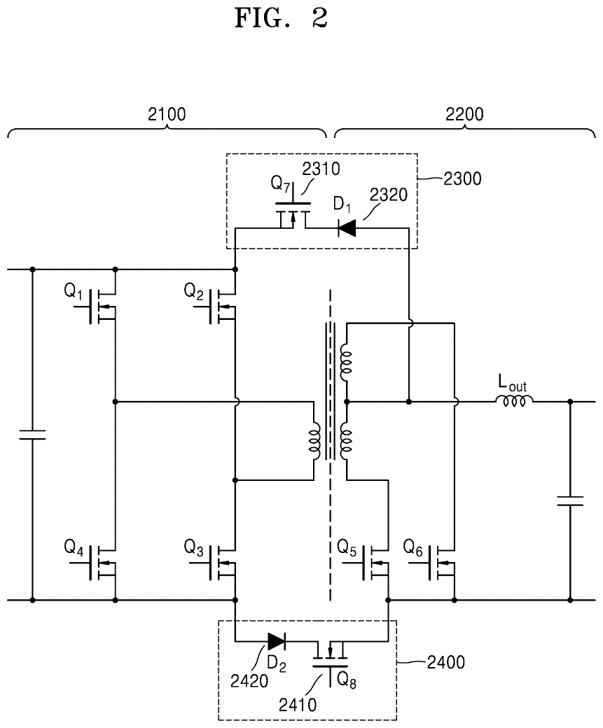

FIG. 2 illustrates a circuit of a PSFB center-tapped converter to which a secondary-side switching element protection circuit s added, according to an embodiment.

Hereinafter, a circuit capable of preventing damage to a plurality of switching elements Q₅ and Q₆ included in a secondary side 2200 side is referred to as a protection circuit or a secondary-side switching element protection circuit.

A converter according to an embodiment may include a primary side 2100 circuit having a full bridge structure and a secondary side 2200 circuit having a center-tap structure. In some embodiments, the converter according to an embodiment may further include a protection circuit which transfers energy from the secondary side 2200 circuit to the primary side 2100 circuit, based on an operation stop. In FIG. 2, it may be understood that the protection circuit according to an embodiment includes a first protection circuit 2300 and a second protection circuit 2400.

More specifically, the PSFG center-tapped converter to which the protection circuit is added, according to an embodiment, may include the primary side 2100 circuit including a full bridge converter and the secondary side 2200 circuit including a center-tap structure.

The full bridge converter may refer to a bridge circuit including four switching elements Q₁, Q₂, Q₃, and Q₄. In some embodiments, the full bridge converter according to an embodiment may be a PSFB converter. The center-tap structure included in the secondary side 2200 circuit may refer to a structure which uses a method of generating two symmetrical voltages by adding a center tap to a coil of the secondary side 2200 circuit of a transformer.

For example, the primary side 2100 circuit may include a plurality of switching elements Q₁, Q₂, Q₃, and Q₄ and a capacitor. In some embodiments, the secondary side 2200 circuit may include a plurality of switching elements Q₅ and Q₆, a capacitor, and an inductor Lₒᵤₜ. For example, the PSFB center-tapped converter to which the protection circuits 2300 and 2400 are added, according to an embodiment may include the transformer.

As described above, the protection circuit according to an embodiment may include the first protection circuit 2300 and the second protection circuit 2400. The first protection circuit 2300 and the second protection circuit 2400 may be respectively connected to the primary side 2100 circuit and the secondary side 2200 circuit, so that damage to the switching elements Q5 and Q6 included in the secondary side 2200 circuit may be prevented.

As described above, the existing PSFB center-tapped converter had a problem in which, when terminating the system while operating in the boost mode, the converter had to unnecessarily enter the buck mode so as to prevent damage to the switching elements Q₅ and Q₆ included in the secondary side 2200 circuit.

To solve these problems, the converter of the disclosure may further include the protection circuits 2300 and 2400 configured to be activated based on the termination of the system while the converter is operating in the boost mode, so that the damage to the switching elements Q₅ and Q₆ included in the secondary side 2200 circuit may be prevented without entering the buck mode.

The activation of the protection circuits 2300 and 2400 may mean that a plurality of switching elements (Q₇ and Q₈) 2310 and 2410 included in the protection circuit are turned on.

In an embodiment, the protection circuit may be a circuit including a plurality of switching elements (Q₇ and Q₈) 2310 and 2410 and a plurality of diodes (D₁ and D₂) 2320 and 2420. In an embodiment, the plurality of switching elements (Q₇ and Q₈) 2310 and 2410 of the protection circuit may be turned on based on an operation stop while the converter is operating in the boost mode.

In an embodiment, the first protection circuit 2300 may be configured as a part which receives energy from the inductor Lₒᵤₜ of the secondary side 2200 circuit, and the second protection circuit 2400 may be configured as a part which forms a ground.

More specifically, the first protection circuit 2300 may include the switching element (Q₇) 2310 and the diode (D₁) 2320. At this time, the protection circuit may be activated so that energy stored in the inductor Lₒᵤₜ of the secondary side 2200 circuit may be transferred to the capacitor of the primary side 2100 circuit through the diode (D₁) 2320 and the switching element (Q₇) 2310 of the protection circuit.

As illustrated in FIG. 2, an anode of the diode (D₁) 2320 of the first protection circuit 2300 may be connected to a first terminal of the inductor Lₒᵤₜ of the secondary side 2200 circuit, and a cathode of the diode (D₁) 2320 of the first protection circuit 2300 may be connected to a first terminal of the switching element (Q₇) 2310 of the first protection circuit 2300. A second terminal of the switching element (Q₇) 2310 of the first protection circuit 2300 may be connected to a first terminal of the capacitor of the primary side 2100 circuit.

For example, the second protection circuit 2400 may include the switching element (Q₈) 2410 and the diode (D₂) 2420. The second protection circuit 2400 may be a part which forms a ground path in the converter to allow the circuit to perform a normal operation.

As illustrated in FIG. 2, an anode of the diode (D₂) 2420 of the second protection circuit 2400 may be connected to a second terminal of the capacitor of the primary side 2100 circuit, and a cathode of the diode (D₂) 2420 of the second protection circuit 2400 may be connected to a first terminal of the switching element (Q₈) 2410 of the second protection circuit 2300. A second terminal of the switching element (Q₈) 2410 of the second protection circuit 2300 may be connected to a first terminal of a capacitor which is connected to a second terminal of the inductor Lₒᵤₜ of the secondary side 2200 circuit.

In summary, the protection circuit connected to the primary side 2100 circuit and the secondary side 2200 circuit may form a path which allows energy stored in the inductor Lₒᵤₜ included in the secondary side 2200 circuit to pass toward the primary side, thereby preventing damage to the switching elements Q₅ and Q₆ of the secondary side 2200. At this time, the path may pass from the inductor Lₒᵤₜ of the secondary side through the diode (D₁) 2320 and the switching element (Q₇) 2310 of the protection circuit 2300, pass through the capacitor of the primary side 2100 circuit and the diode (D₂) 2420 and the switching element (Q₈) 2410 of the protection circuit 2400, pass through the capacitor of the secondary side 2200 circuit, and pass through the inductor Lₒᵤₜ of the secondary side 2200 circuit again.

As described above, the protection circuit according to an embodiment may be activated based on an operation stop while the converter is operating in the boost mode. The diodes (D₁ and D₂) 2320 and 2420 included in the protection circuit may prevent the formation of the path, based on a state in which the converter operates in the buck mode. More specifically, the diodes (D₁ and D₂) 2320 and 2420 may prevent an unintentional formation of a path which is connected from the secondary side 2200 to the primary side 2100 in case that the converter operates in the buck mode.

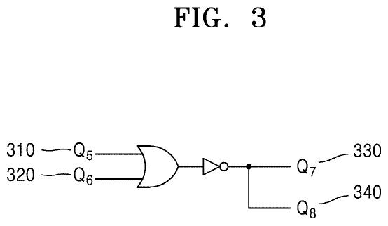

FIG. 3 illustrates an implementation of a secondary-side switching element protection circuit according to an embodiment.

A logic circuit may refer to an electronic circuit which processes digital signals and performs logical operations. According to an embodiment, the protection circuit may include a logic circuit using a NOR gate. At this time, the NOR gate may refer to a gate which inverts an output of an OR gate, and the OR gate may refer to a gate which outputs true in case that at least one of input signals is true.

According to an embodiment, the protection circuit may include a logic circuit which receives, as input signals 310 and 320, operation signals (e.g., gate signals) of a plurality of switching elements Q₅ and Q₆ included in a secondary side circuit. At this time, output signals 330 and 340 of the logic circuit included in the protection circuit are a result of performing a NOR operation by using, as the input signals 310 and 320, the operation signals of the plurality of switching elements Q₅ and Q₆ included in the secondary side circuit, and may be input as operation signals of a plurality of switching elements Q₇ and Q₈ of the protection circuit.

Hereinafter, a first switching element included in the secondary side circuit is defined as Q₅, and a second switching element included in the secondary side circuit is defined as Q₆.

More specifically, the protection circuit may be a circuit which turns on the plurality of switching elements included in the protection circuit, based on off signals of the first switching element and the second switching element included in the secondary side circuit.

At this time, the off signals of the first switching element and the second switching element included in the secondary side circuit may be signals applied to the respective switching elements, based on the termination of the system in the boost mode.

More specifically, in case that the PSFB center-tapped circuit operates in the boost mode, at least one of the plurality of switching elements included in the secondary side circuit is in an on state, and thus, the off signals of the first switching element and the second switching element included in the secondary side circuit may mean that the system is terminated in the boost mode.

For example, the plurality of switching elements included in the protection circuit may be turned on according to the logic circuit of the protection circuit, based on the application of the off signals to the first switching element and the second switching element included in the secondary side circuit. For example, the signals of the plurality of switching elements Q₇ and Q₈ of the protection circuit corresponding to the output signals 330 and 340 may become 1, based on a state in which the signals of the plurality of switching elements Q₅ and Q₆ included in the secondary side circuit corresponding to the input signal 310 and 320 are 0. At this time, as described above with reference to FIG. 2, the path may be formed to transfer energy stored in the inductor included in the secondary side circuit from the secondary side to the primary side by the plurality of turned-on switching elements Q₇ and Q₈ of the protection circuit.

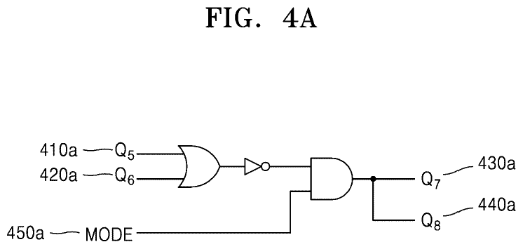

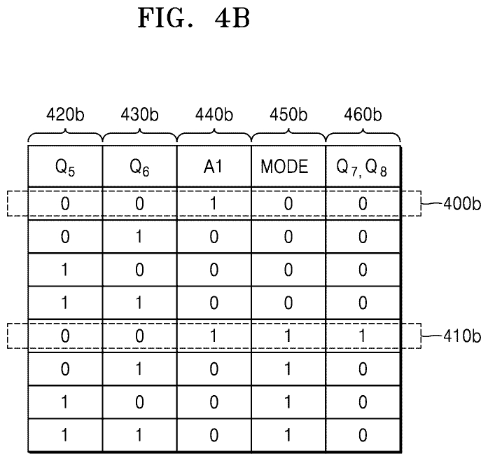

FIGS. 4A and 4B illustrate implementations of a secondary-side switching element protection circuit according to another embodiment.

According to an embodiment, the protection circuit may include a logic circuit in which a signal 450a related to an operation mode of a converter illustrated in FIG. 4A is added as an input signal. At this time, the logic circuit may include both a NOR gate and an AND gate.

More specifically, the protection circuit may be a circuit which turns on a plurality of switching elements Q₇ and Q₈ included in the protection circuit, based on off signals 410a and 420a of a first switching element and a second switching element included in the secondary side circuit and the operation mode of the converter.

At this time, the logic circuit may perform a NOR operation by using, as the input signals, the signals 410a and 420a of the first switching element and the signal of the second switching element included in the secondary side circuit, and may perform an AND operation by using, as the input signals, a result of the NOR operation and the signal 450a related to the operation mode of the converter. For example, the AND operation may refer to an operation which outputs true only in case that all the inputs are true.

The protection circuit according to an embodiment may maintain the turned-off state of the plurality of switching elements included in the protection circuit, based on a state in which the operation mode of the converter is the buck mode. For example, even in case that the first switching element Q₅ and the second switching element Q₆ included in the secondary side circuit are turned off, the protection circuit may maintain the turned-off state of the plurality of switching elements Q₇ and Q₈ included in the protection circuit, based on a state in which the operation mode of the converter is the buck mode.

According to an embodiment, the final output signals 430a and 440a of the logic circuit in which the signal 450a related to the operation mode of the converter, which may be included in the protection circuit, is added as the input signal may refer to the signals of the plurality of switching elements Q₇ and Q₈ included in the protection circuit.

As described above, the protection circuit including the logic circuit in which the signal 450a related to the operation mode of the converter is added as the input signal may prevent the protection circuit from being activated in case that the converter operates in the buck mode.

More specifically, the plurality of switching elements Q₅ and Q₆ included in the secondary side circuit of the converter may be simultaneously turned off in the low power transfer of the buck mode. At this time, the protection circuit including the logic circuit in which the signal 450a related to the operation mode of the converter is added as the input signal may be used to prevent the protection circuit from being unnecessarily activated due to the turn-off of the plurality of switching elements Q₅ and Q₆ included in the secondary side circuit in the low power transfer of the buck mode.

For example, the signal 450a related to the operation mode of the converter may be transmitted to the protection circuit through a digital signal processor (DSP) or a microcontroller unit (MCU). In this case, the DSP may refer to a special-purpose microprocessor optimized to perform real-time signal processing tasks, and the MCU may refer to a small computer which performs control tasks in an embedded system. However, a method by which the protection circuit obtains the signal 450a related to the operation mode of the converter is not limited to those described above.

FIG. 4B is a table showing the operation of the logic circuit in which the signal related to the operation mode of the converter is added as the input signal.

A first column 420b and a second column 430b of the table may indicate the signals of the switching elements Q₅ and Q₆ included in the secondary side. More specifically, 0 may mean that the switching element is in an off state, and 1 may mean that the switching element is in an on state.

A third column 440b of the table may indicate the output signal of the NOR gate which receives, as the input signals, the signals of the switching elements Q₅ and Q₆ included in the secondary side.

Furthermore, a fourth column 450b of the table may indicate the signal related to the operation mode of the converter. In this case, 0 may mean that the converter is operating in a mode other than the boost mode, and 1 may mean that the converter is operating in the boost mode.

A fifth column 460b of the table may indicate the signals of the plurality of switching elements Q₇ and Q₈ included in the protection circuit.

At this time, the signals of the plurality of switching elements Q₇ and Q₈ included in the protection circuit may be a result of performing a NOR operation by using, as the input signals, the signals of the switching elements Q₅ and Q₆ included in the secondary side circuit and a result of performing an AND operation by using, as the input signals, the signal related to the operation mode of the converter.

For example, 0 may mean that the plurality of switching elements Q₇ and Q₈ included in the protection circuit are in an off state, and 1 may mean that the plurality of switching elements Q₇ and Q₈ included in the protection circuit are in an on state. At this time, in case that the switching elements Q₇ and Q₈ included in the protection circuit are turned on, the protection circuit may be considered to be activated.

In case that the protection circuit including the logic circuit in which the operation mode is added as the input signal, according to an embodiment, is used, even when the switching elements Q₅ and Q₆ included in the secondary side are in an off state, the switching elements Q₇ and Q₈ included in the protection circuit may not be turned on when the converter is operating in the buck mode (400b). For example, the switching elements Q₇ and Q₈ of the protection circuit including the logic circuit in which the operation mode is added as the input signal may be turned on based on a state in which the switching elements Q₅ and Q₆ included in the secondary side are in an off state and the converter is operating in the boost mode (410b). This may prevent the protection circuit from being unnecessarily activated in the buck mode.

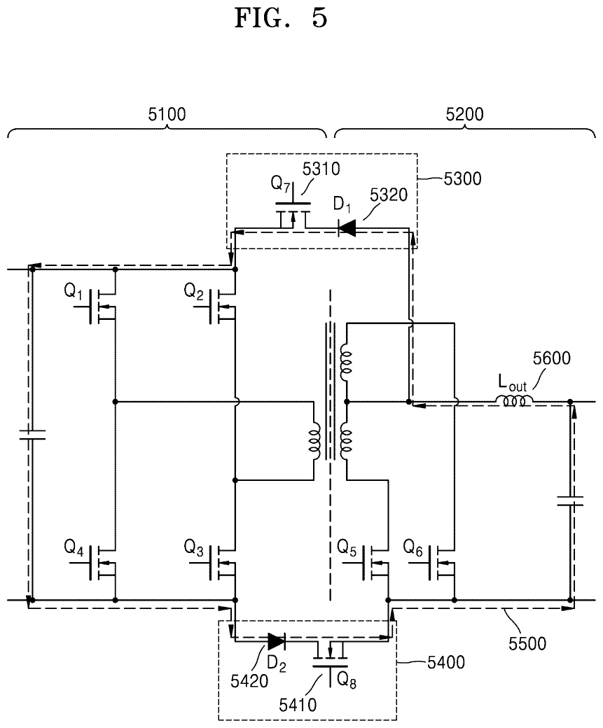

FIG. 5 illustrates an energy transfer path 5500 in case that secondary-side switching element protection circuits 5300 and 5400 are activated, according to an embodiment.

The protection circuits 5300 and 5400 may be a circuit which prevents damage to a plurality of switching elements Q₅ and Q₆ included in a secondary side 5200 circuit due to a voltage induced across an inductor (Lₒᵤₜ) 5600 of the secondary side 5200 circuit, based on a state in which a system is terminated while a converter is operating in a boost mode. For example, a plurality of switching elements (Q₇ and Q₈) 5310 and 5410 of the protection circuits 5300 and 5400 may be turned on based on a state in which the system is terminated while the converter is operating in the boost mode.

As described above, the switching elements (Q₇ and Q₈) 5310 and 5410 included in the protection circuits 5300 and 5400 may be turned on based on a state in which the plurality of switching elements Q₅ and Q₆ included in the secondary side 5200 circuit are in an off state by the logic circuit described above. In other words, the protection circuits 5300 and 5400 may be a circuit which turns on the plurality of switching elements (Q₇ and Q₈) 5310 and 5410 included in the protection circuits 5300 and 5400, based on off signals of the first switching element Q₅ and the second switching element Q₆ included in the secondary side 5200 circuit.

For example, in case that the switching elements (Q₇ and Q₈) 5310 and 5410 respectively included in the protection circuits 5300 and 5400 are turned on, the protection circuits 5300 and 5400 may be considered to be activated. At this time, based on the activation of the protection circuits 5300 and 5400, the path 5500 may be formed so that energy formed by the voltage induced across the inductor (Lₒᵤₜ) 5600 of the secondary side 5200 circuit is transferred from the secondary side 5200 to the primary side 5100.

Due to the activation of the protection circuits 5300 and 5400, the energy stored in the inductor (Lₒᵤₜ) 5600 of the secondary side 5200 circuit, which may cause damage to the plurality of switching elements Q₅ and Q₆ included in the secondary side 5200 circuit, may be transferred from the secondary side 5200 to the primary side 5100. At this time, the energy stored in the inductor (Lₒᵤₜ) 5600 of the secondary side 5200 circuit may be transferred to a capacitor of the primary side 5100 circuit through diodes (D₁ and D₂) 5320 and 5420 and the plurality of switching elements (Q₇ and Q₈) 5310 and 5410 respectively included in the protection circuits 5300 and 5400.

More specifically, the path 5500 may pass from the inductor (Lₒᵤₜ) 5600 of the secondary side 5200 circuit through the diode (D₁) 5320 and the switching element (Q₇) 5310 of the protection circuit 5300, pass through the capacitor of the primary side 5100 circuit, through the diode (D₂) 5420 and the switching element (Q₈) 5410 of the protection circuit 5400, pass through the capacitor of the secondary side 5200 circuit, and pass through the inductor (Lₒᵤₜ) 5600 of the secondary side 5200 circuit again.

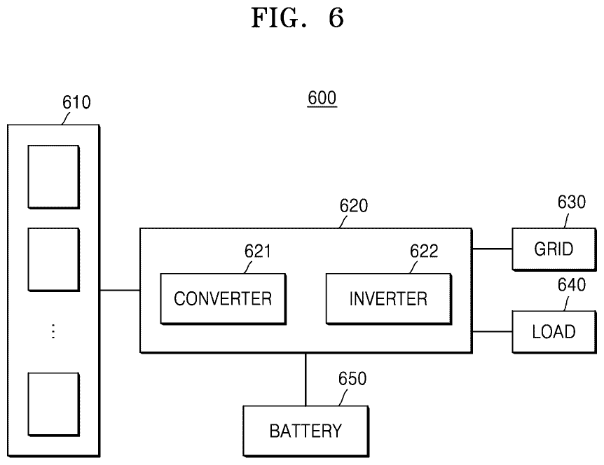

FIG. 6 schematically illustrates an example of a photovoltaic power generation system 600 according to an embodiment.

Referring to FIG. 6, the photovoltaic power generation system 600 according to an embodiment may include one or more photovoltaic panels 610, a power conversion device 620, a grid 630, a load 640, and/or a power storage device 650.

The one or more photovoltaic panels 610 are devices which generate electrical energy from sunlight energy and may include a plurality of solar cells.

The power conversion device 620 may refer to a device which converts power generated by the photovoltaic panel 610 and transmit the converted power to the load 640, the grid 630, and the like. In this case, the power conversion device 620 may include a converter 621, an inverter 622, and the like. A DC-DC converter, which is a type of converter 621 included in the power conversion device 620, may regulate a voltage of the power generated by the photovoltaic panel 610. In some embodiments, the inverter 622, which may be included in the power conversion device 620, may convert DC power generated by the photovoltaic panel 610 into AC power. Devices, which may be included in the power conversion device 620, are not limited to the devices described above.

The grid 630 may refer to an infrastructure system for generating, transferring, and distributing electric energy generated by the photovoltaic power generation system 600. In this case, the grid 630 may include an infrastructure system, such as a power plant, a substation, or a power line. For example, the grid 630 may transfer electric energy generated by the power plant to the photovoltaic power generation system 600 or may transfer surplus power generated by the photovoltaic power generation system 600 to the outside of the photovoltaic power generation system 600.

The load 640 may refer to an object which consumes electricity generated by the photovoltaic power generation system 600. For example, the load 640 may include home appliances, such as washing machines, refrigerators, or televisions (TVs).

The power storage device 650 may receive and store power generated by the photovoltaic panel 610. For example, the power storage device 650 may include an energy storage system (ESS) which may store the generated power and may efficiently supply the power to the load 640 when the load 640 requires the power.

In addition to the components illustrated in FIG. 6, the photovoltaic power generation system 600 may include any suitable component for operating the photovoltaic power generation system 600. For example, the photovoltaic power generation system 600 may include a connection section through which power is moved within the photovoltaic power generation system 600, a distribution panel which distributes power within the photovoltaic power generation system 600, a monitoring device which monitors the photovoltaic power generation system 600, and the like.

For example, the power conversion device 620 may include the converter 621 and the inverter 622.

The converter 621 may convert DC power into DC power within the photovoltaic power generation system 600. For example, the converter 621 may receive DC power generated by the one or more photovoltaic panels 610 and output DC power for voltage regulation, power management, efficiency improvement, or the like within the photovoltaic power generation system 600. For example, the converter 621 may receive DC power and output DC power for storage in the power storage device 650.

The converter 621 of FIG. 6 may be one of the converters according to various embodiments described above with reference to FIGS. 1 to 5. In some embodiments, the converter 621 of FIG. 6 may include a primary side circuit having a full bridge structure and a secondary side circuit having a center tap structure, and may further include a protection circuit which transfers energy from the secondary side circuit to the primary side circuit, based on the stopping of the operation.

The inverter 622 may convert DC power into AC power within the photovoltaic power generation system 600. For example, the inverter 622 may receive DC power and supply AC power to the grid 630 or the load 640.

The converter according to an embodiment may be used by being included in the power conversion system within the photovoltaic power generation system, as described above, but the use of the converter is not necessarily limited to those described above.

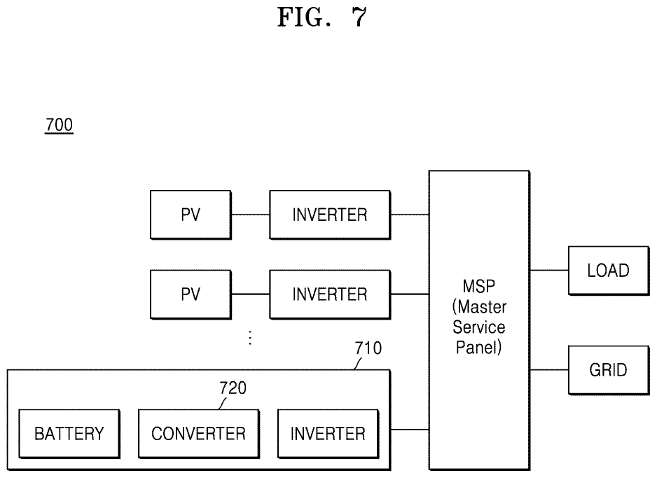

FIG. 7 schematically illustrates another example of a photovoltaic power generation system 700 according to an embodiment.

Referring to FIG. 7, the photovoltaic power generation system 700 according to an embodiment may include one or more photovoltaic panels PV, inverters respectively connected to the photovoltaic panels, an ESS 710, a master service panel (MSP), a load, and/or a grid. In some embodiments, the ESS 710 may include a battery, an inverter, and/or a converter 720.

According to an embodiment, the MSP may be connected to the inverters, the ESS 710, the load, and/or the grid. In this case, the MSP may distribute the generated power to the load or the like. Because the one or more photovoltaic panels PV, the load, and the grid included in the photovoltaic power generation system 700 according to an embodiment are described above with reference to FIG. 6, a detailed description thereof is omitted.

The photovoltaic power generation system 700 according to an embodiment may include the inverters respectively connected to the photovoltaic panels PV. In this case, the inverters respectively connected to the photovoltaic panels PV may be microinverters (MIs) and may convert power generated by the respective connected photovoltaic panels PV.

The MI may be a small photovoltaic inverter which is installed in the photovoltaic panel PV. Unlike string inverters (e.g., the inverter 622) connected to a plurality of photovoltaic panels, the MIs may be independently connected to the photovoltaic panels PV, respectively, and convert power. For example, a single MI may be connected to a single photovoltaic panel PV. In this case, the MI may convert the power generated by the photovoltaic panel PV, and the converted power may be output to the load or the power grid.

The photovoltaic power generation system 700 according to an embodiment may include the ESS 710. In this case, the ESS 710 may store the generated power and may supply the power to the load when the load requires the power, as described above with reference to FIG. 6. For example, the ESS 710 according to an embodiment may include the battery, the converter 720, and the inverter. For example, the ESS 710 may be provided in a form in which the battery, the converter 720, and the inverter are integrally formed as one body.

The converter 720 of FIG. 7 may be used by being included in the ESS 710 and may be one of the converters according to various embodiments described above with reference to FIGS. 1 to 5. For example, the converter 720 of FIG. 7 may include a primary side circuit having a full bridge structure and a secondary side circuit having a center tap structure, and may further include a protection circuit which transfers energy from the secondary side circuit to the primary side circuit, based on the stopping of the operation.

As described above with reference to FIG. 6, the photovoltaic power generation system 700 illustrated in FIG. 7 may also include any suitable component for operating the photovoltaic power generation system 700. Because any suitable component that may be included in the photovoltaic power generation system 700 has been described above with reference to FIG. 6, a detailed description thereof is omitted.

The converter according to an embodiment may be used by being included in the ESS 710 within the photovoltaic power generation system 700, as described above, but the use of the converter is not necessarily limited to those described above.

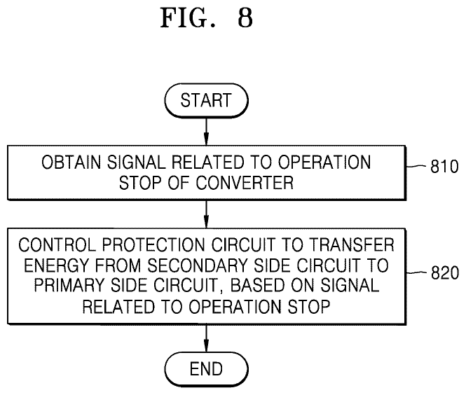

FIG. 8 is a flowchart illustrating a method of controlling a converter, according to an embodiment.

The method of controlling the converter, which is illustrated in FIG. 8, may be performed by a converter, a processor included in the converter, or elements included in the converter.

In operation 810, the converter according to the disclosure, the processor included in the converter, or the components included in the converter may obtain a signal related to an operation stop of the converter.

In operation 820, the converter according to the disclosure, the processor included in the converter, or the components included in the converter may control the protection circuit to transfer energy from the secondary side circuit to the primary side circuit, based on the signal related to the operation stop. In an embodiment, the controlling of the protection circuit to transfer the energy may be performed by using the plurality of switching elements and the plurality of diodes of the protection circuit. More specifically, the controlling of the protection circuit to transfer the energy may be performed by using the protection circuit including the plurality of switching elements and the plurality of diodes.

In an embodiment, the signal related to the operation stop may be obtained while the converter is operating in the boost mode, and the controlling of the protection circuit to transfer the energy may include turning on the plurality of switching elements of the protection circuit.

In an embodiment, the signal related to the operation stop may be the off signal of the first switching element and the second switching element included in the secondary side circuit, and the controlling of the protection circuit to transfer the energy may include turning on the plurality of switching elements included in the protection circuit, based on the off signal.

In another embodiment, the obtaining of the signal related to the operation stop may further include obtaining a signal related to the operation mode of the converter, the signal related to the operation stop may be the off signal of the first switching element and the second switching element included in the secondary side circuit, and the controlling of the protection circuit to transfer the energy may include turning on the plurality of switching elements included in the protection circuit, based on the off signal and the signal related to the operation mode of the converter.

In an embodiment, the controlling of the protection circuit to transfer the energy may include maintaining the turned-off state of the plurality of switching elements included in the protection circuit, based on a state in which the signal related to the operating mode of the converter is a signal related to the buck mode.

Because various operations related to the method of controlling the converter, according to the disclosure, have been described above, a detailed description thereof is omitted.

According to the solution to problem described above, the secondary side switching element protection circuit may be added to the bidirectionally operable PFSB center-tapped converter, thereby protecting the switching elements of the secondary side circuit and urgently terminating the system even while the converter is operating in the boost mode.

Operations constituting methods according to the disclosure may be performed in any suitable order unless otherwise indicated herein or otherwise clearly contradicted by context. The disclosure is not necessarily limited by the order of operations. The use of any and all examples or exemplary terms (e.g., “such as”) provided herein is simply intended to describe the disclosure in detail, and the scope of the disclosure is not limited by the examples or exemplary terms unless otherwise claimed. In addition, it will be understood by those of ordinary skill in the art that various modifications, combinations and changes may be made according to design conditions and factors within the scope of the appended claims or equivalents thereof.

Therefore, it will be understood that the spirit of the disclosure should not be limited to the embodiments described above, and the claims and all equivalent modifications fall within the scope of the disclosure.

What is claimed is:

1. A converter comprising:
a primary side circuit having a full bridge structure; and
a secondary side circuit having a center-tap structure,
wherein the converter further comprises a protection circuit configured to transfer energy from the secondary side circuit to the primary side circuit, based on an operation stop.

2. The converter of claim 1, wherein the protection circuit comprises a plurality of switching elements and a plurality of diodes.

3. The converter of claim 1, wherein plurality of switching elements of the protection circuit are turned on based on the operation stop while the converter is operating in a boost mode.

4. The converter of claim 1, wherein the protection circuit is further configured to turn on plurality of switching elements included in the protection circuit, based on off signals of a first switching element and a second switching element included in the secondary side circuit.

5. The converter of claim 4, wherein the protection circuit is further configured to turn on the plurality of switching elements included in the protection circuit, based on the off signals of the first switching element and the second switching element included in the secondary side circuit and an operation mode of the converter.

6. The converter of claim 5, wherein the protection circuit is further configured to maintain turned-off states of the plurality of switching elements included in the protection circuit, based on a state in which the operation mode of the converter is a buck mode.

7. A photovoltaic power generation system comprising:
one or more photovoltaic panels; and
a power conversion device configured to convert power generated by the one or more photovoltaic panels and transfer the converted power,
wherein the power conversion device comprises a converter,
wherein the converter comprises:
a primary side circuit having a full bridge structure; and
a secondary side circuit having a center tap structure,
wherein the photovoltaic power generation system further comprises a protection circuit configured to transfer energy from the secondary side circuit to the primary side circuit, based on an operation stop.

8. The photovoltaic power generation system of claim 7, wherein the protection circuit comprises a plurality of switching elements and a plurality of diodes.

9. The photovoltaic power generation system of claim 7, wherein plurality of switching elements of the protection circuit are turned on based on the operation stop while the converter is operating in a boost mode.

10. The photovoltaic power generation system of claim 7, wherein the protection circuit is further configured to turn on plurality of switching elements included in the protection circuit, based on off signals of a first switching element and a second switching element included in the secondary side circuit.

11. The photovoltaic power generation system of claim 10, wherein the protection circuit is further configured to turn on the plurality of switching elements included in the protection circuit, based on the off signals of the first switching element and the second switching element included in the secondary side circuit and an operation mode of the converter.

12. The photovoltaic power generation system of claim 11, wherein the protection circuit is further configured to maintain turned-off states of the plurality of switching elements included in the protection circuit, based on a state in which the operation mode of the converter is a buck mode.

13. A method of controlling a converter, the method comprising:
obtaining a signal related to an operation stop of the converter; and
controlling a protection circuit to transfer energy from a secondary side circuit to a primary side circuit, based on the signal related to the operation stop.

14. The method of claim 13, wherein the controlling of the protection circuit to transmit the energy is performed by using a plurality of switching elements and a plurality of diodes of the protection circuit.

15. The method of claim 13, wherein the signal related to the operation stop is obtained while the converter is operating in a boost mode, and
the controlling of the protection circuit to transmit the energy comprises turning on a plurality of switching elements of the protection circuit.

16. The method of claim 13, wherein the signal related to the operation stop is off signals of a first switching element and a second switching element included in the secondary side circuit, and
the controlling of the protection circuit to transmit the energy comprises turning on a plurality of switching elements included in the protection circuit, based on the off signals.

17. The method of claim 13, wherein the obtaining of the signal related to the operation stop comprises obtaining a signal related to an operation mode of the converter,
the signal related to the operation stop is off signals of a first switching element and a second switching element included in the secondary side circuit, and
the controlling of the protection circuit to transmit the energy comprises turning on a plurality of switching elements included in the protection circuit, based on the off signals and the signal related to the operation mode of the converter.

18. The method of claim 17, wherein the controlling of the protection circuit to transmit the energy comprises maintaining turned-off states of the plurality of switching elements included in the protection circuit, based on a state in which the signal related to the operation mode of the converter is a signal related to a buck mode.
